(19) United States
(12) Patent Application Publication
(10) Pub. No.: US 2025/0263510 A1
(43) Pub. Date: Aug. 21, 2025

(54) BIO-BASED, HIGH-SOLID LOW VISCOSITY ACRYLIC RESIN AND PREPARATION METHOD THEREOF

(71) Applicant: IZEL KIMYA SANAYI VE TICARET ANONIM SIRKETI, Dilovasi (TR)

(72) Inventors: Cemil DIZMAN, Dilovasi (TR); Elif CERRAHOGLU KAÇAKGIL, Dilovasi (TR); Aleyna TURANLI, Dilovasi (TR); Recep Furkan TURAN, Dilovasi (TR); Levent BABAYIGIT, Dilovasi (TR); Turdimuhammad ABDULLAH, Dilovasi (TR)

(21) Appl. No.: 18/582,934

(22) Filed: Feb. 21, 2024

(51) Int. Cl. C08F 220/18

(52) U.S. Cl. CPC C08F 220/1818

(57) ABSTRACT

Disclosed is a kind of bio-based, high-solid low viscosity acrylic resin and a preparation method thereof. According to one aspect, provided is a bio-based high-solid acrylic resin prepared from a composition including: 20-80 parts of bio-based acrylates, 8-12 parts of 2-Hydroxyethyl Methacrylate (HEMA) or 2-Hydroxyethyl Acrylate (HEA) or 2-hydropropyl methacrylate (HPMA), 10-30 parts of low-toxic solvent, 3-5 parts of Methacrylic Acid (MAA) or Acrylic Acid (AA), 3-5 parts of a glycidyl ester of neodecanoic acid, and 0.3-5 part of an initiator.

### CROSS-REFERENCE TO RELATED APPLICATIONS

Not applicable.

### BACKGROUND OF THE INVENTION

The invention relates to a kind of bio-based, high-solid low viscosity acrylic resin and preparation method thereof. Bio-based high-solid acrylic resins, described in the current invention, are widely used in coatings, paints, adhesives, and sealants. The versatility and properties of high-solid acrylic resins make them indispensable in creating durable, efficient, and environmentally conscious coatings and adhesives for a wide range of applications. In the case of coating applications, these resins offer excellent corrosion resistance, durability, and good adhesion properties, making them suitable for architectural, automotive, and industrial coatings. In adhesives and sealants, bio-based, high-solid acrylic resins provide improved strength and bonding. They can be also applied in printing inks, wood coatings, automotive finishes, metal coatings, plastic coatings, floor coatings, and textile coatings. The growing interest in high-solid acrylic resins derived from bioresources aligns with the demand for high-performance materials, strict environmental regulations addressing concerns about air quality (such as lower VOC content), and emphasis on environmental sustainability and circular economy.

The global acrylic resin market size was valued at approximately $18 billion in 2021 and is estimated to reach about $28.4 billion by 2030 with a compound annual growth rate (CAGR) of around 6.25%. Acrylic resin is a polymeric solution containing acrylic monomers and can exist as a solution, solid, or dispersion. It is produced from esters of methacrylic acids, acrylic, or their derivatives. Acrylic resins are versatile; as different chemical groups can be introduced to tailor their properties for various applications. Currently, these resins are widely employed in the coatings and paints industry, available in solvent-based or water-based forms based on industrial needs. They are favored for their excellent photochemical and chemical resistance. The dispersion and viscosity of the acrylic resin, influenced by factors like molecular weight and glass transition temperature, determine the flexibility and hardness of the final coating or film.

Acrylic resins can be categorized as pure (consisting only of acrylic monomers) or complex (combining different monomers with acrylic polymers) based on their composition.

Reducing volatile organic compound (VOC) emissions is a significant challenge in the resin industry, particularly in coating and painting. Regular exposure to VOCs from organic solvent dilutants can lead to health issues such as irritation in the nose, eyes, and throat, loss of coordination, headaches, kidney or liver damage, and impacts on the central nervous system. Some VOCs are considered carcinogenic, and some are suspected carcinogens. Solvent-based acrylic resins release high levels of VOCs, making them unsustainable. As a result, there is a growing trend in research and product development towards high-solid, low-viscosity acrylic resins that release less amount of VOCs. CN108864359B demonstrates that the acrylic resin adhesive with a solid content higher than 50% is achieved by adding acrylic ester soft monomers, hard monomers, functional monomers, organic solvents, and initiators. Patent CN101407568A discloses the preparation of acrylic resin through radical polymerization employing a complex initiator system and a chain transfer agent. The acrylic resin has a solid content above 70% and exhibits a viscosity within the range of 1000 to 4000 MPa.s. Furthermore, various innovative techniques, including solution and separation polymerization (Diakoumakos, Constantinos D, et al. Journal of Coatings Technology 72 (2000): 61-70), altering initiator types (Taheri, Maryam, Mehdi Jahanfar, and Kenji Ogino. Designed Monomers and Polymers 22.1 (2019): 213-25.), and incorporating functional monomers into acrylic resins (Wang, Xumeng, et al. Journal of Saudi Chemical Society 23.7 (2019): 992-98.), have been explored to produce high-solid, low-viscosity acrylic resins.

Another emerging trend in the resin industry is the substitution of petrochemical-based materials with bio-based alternatives. This shift has gained momentum due to the escalating costs of petrochemicals and a heightened focus on sustainability concerns. Furthermore, the extensive use of resins derived from petroleum or synthetically created substances poses health hazards and negative environmental impacts. In contrast, bio-based materials have renewable sources and, in certain instances, are biodegradable, offering the potential to foster a more circular economy and enhance overall sustainability efforts. This transition not only addresses economic challenges but also aligns with environmental and health-conscious objectives, reflecting a growing commitment to a greener, more sustainable future in the resin industry. U.S. Pat. No. 9,581,924B2 describes (Meth)acrylate resins containing a bio-based (Meth)acrylate monomer, which incorporates a rosin or isosorbide component derived from natural sources. Patent CN112300343B presents a bio-based acrylate emulsion comprising both synthetic and bio-based alkyl acrylate monomers, organic carboxylic acid, reactive anionic emulsifier, nonionic emulsifier, buffer, initiator, reactive stable monomer and neutralizer. the preparation of acrylic resin through radical polymerization employing a complex initiator system and a chain transfer agent. Nevertheless, their application is limited to toner, carrier coating, and interior wall coating only, and is not suitable for coatings and paint applications that require high durability and high chemical and corrosion resistance (e.g.: coating of automotive and industrial equipment).

### SUMMARY OF THE INVENTION

The present invention aims to address the previously mentioned challenges by introducing a revolutionary, entirely bio-based, high-solid, low-viscosity acrylic resin, and their preparation method. The utilization of bio-based materials in this novel acrylic resin formulation marks a significant advancement in the field. This progressive approach not only mitigates potential health hazards associated with traditional chemical ingredients but also serves as a powerful tool in minimizing adverse environmental impacts. By reducing our reliance on fossil fuels and petrochemicals, this bio-based resin promotes a more sustainable, eco-friendly approach to material production. Furthermore, the adoption of this bio-based acrylic resin contributes to the establishment of a more circular economy. This sustainable production method, coupled with the use of renewable resources, not only reduces waste but also fosters a closed-loop system where materials are reused and recycled, further enhancing overall sustainability.

The high solidity characteristic of this resin drastically reduces the emission of Volatile Organic Compounds (VOCs). This significant reduction in VOC emissions aligns with increasingly strict environmental regulations, making this acrylic resin a responsible and compliant choice for a cleaner planet. Moreover, the coating film derived from this groundbreaking resin exhibits many exceptional qualities. It possesses exceptional weather resistance, ensuring that coatings endure and protect surfaces under the harshest of conditions. The high durability of the coating film ensures that it withstands the test of time, offering a long-lasting solution for various applications.

One of the most remarkable attributes of the resin is its high chemical and corrosion resistance. This resistance to chemical agents and corrosion is invaluable in scenarios where protective coatings are crucial, such as in industrial, marine, or automotive applications. The water tolerance of the resin is equally noteworthy, as it ensures the coating's integrity even in wet and humid conditions. The high hardness and glossiness of the coating film set it apart as an ideal choice for applications requiring not only protection but also aesthetics. These attributes make it suitable for use in a wide range of applications, including architectural coatings, automotive finishes, and industrial protective coatings.

According to one aspect the present invention provides a bio-based high-solid acrylic resin with solid content above 70% and viscosity lower than 20.000 cP, and prepared from a composition characterised in comprising; 20-80 parts of bio-based acrylates, 8-12 parts of 2-Hydroxyethyl Methacrylate (HEMA) or 2-Hydroxyethyl acrylate (HEA) or 2-hydropropyl methacrylate (HPMA), 10-30 parts of low-toxic solvent, 3-5 parts of Methacrylic Acid (MAA) or Acrylic Acid (AA), 3-5 parts of a glycidyl ester of neodecanoic acid, 0.3-5 part of an initiator.

In some embodiments the composition comprises: 25 parts of low-toxic solvent preferably n-Butyl Acetate, 4 parts of Methacrylic Acid (MAA) or Acrylic Acid (AA), 4 parts of glycidyl ester of neodecanoic acid (Cardura E10), 12 parts of 2-Hydroxyethyl Methacrylate (HEMA) or 2-Hydroxyethyl Acrylate (HEA), 80 parts of bio-based acrylate preferably lauryl methacrylate (LMA) and/or stearyl methacrylate (SMA), and 0.5 parts of initiator preferably Trigonox B.

According to one aspect the present invention provides a method to prepare a bio-based high-solid acrylic resin from said composition comprising the process steps of:
A) heating low-toxic solvent to a temperature of 60-160° C. under inert atmosphere,
B) preparing a mixture of selected bio-based acrylates, 2-Hydroxyethyl Methacrylate (HEMA) or 2-Hydroxyethyl Acrylate (HEA) or 2-hydropropyl methacrylate (HPMA), Methacrylic Acid (MAA) or Acrylic Acid (AA), glycidyl ester of neodecanoic acid, initiator at a temperature of 20-30° C. and stirring until the mixture becomes clear and transparent,
C) adding the prepared mixture to low-toxic solvent dropwise while maintaining the temperature at 60-160° C.,
D) checking, viscosity (Lower than 20.000 cP), and solid content (above 70%) of the resin every one hour during the reaction,
E) terminating the reaction once the solid content of the synthesized resin is above 70% and storing the resin.

In some embodiments the bio-based acrylates are selected from long-chain alkyl acrylate/methacrylates: specifically, stearyl acrylate, stearyl methacrylate, lauryl acrylate, lauryl methacrylate, behenyl acrylate, and behenyl methacrylate.

In some embodiments the initiator for preparing acrylic resin is selected from dialkyl peroxides such as d-t-butyl peroxide (Trigonox B), d-t-amyl peroxide (Luperox DTA), diethyl Peroxide (Trigonox 21), Diisopropyl Peroxide (Trigonox I), and Diisobutyl Peroxide (Trigonox IB).

In some embodiments the solvent for preparing acrylic resin comprises one or more low-toxicity solvents, preferably bio-based solvents. In specific embodiments, the solvent comprises one or more n-butyl acetate, t-butyl acetate, isobutyl acetate, propyl acetate, isopropyl acetate, methyl acetate, and ethyl acetate. In other embodiments, the solvent comprises one or more amyl acetate-n, ethylene glycol ether acetate, 2-butoxyethyl acetate, and diethylene glycol monobutyl ether acetate.

### DETAILED DESCRIPTION OF THE INVENTION

At The invention is further described below with reference to examples, which include only some of the described embodiments.

The present invention provides a kind of bio-based, high-solid low viscosity acrylic resin and preparation method thereof. The coating film prepared by the resin has the characteristics of good weather resistance, high durability, high chemical and corrosion resistance, water tolerance, high hardness, high fullness, high glossiness, low VOC level, and the like.

An aspect of the invention provides a kind of bio-based, high solid viscosity acrylic resin with solid content above 70% and viscosity lower than 20.000 cP, which comprises 20-80 parts of bio-based acrylates, 8-12 parts of 2-Hydroxyethyl Methacrylate (HEMA) or 2-Hydroxyethyl Acrylate (HEA) or 2-hydropropyl methacrylate (HPMA), 10-30 parts of low-toxic solvent, 3-5 parts of Methacrylic Acid (MAA) or Acrylic Acid (AA), 3-5 parts of a glycidyl ester of neodecanoic acid, 0.3-5 part of an initiator. The bio-based acrylates are selected from long-chain alkyl acrylate/methacrylates: specifically, stearyl acrylate, stearyl methacrylate, lauryl acrylate, lauryl methacrylate, behenyl acrylate, and behenyl methacrylate. The initiator for preparing acrylic resin is selected from dialkyl peroxides such as d-t-butyl peroxide (Trigonox B), d-t-amyl peroxide (Luperox DTA), diethyl Peroxide (Trigonox 21), Diisopropyl Peroxide (Trigonox I), and Diisobutyl Peroxide (Trigonox IB). The solvent for preparing acrylic resin comprises one or more low-toxicity solvents, preferably bio-based solvents. In specific embodiments, the solvent comprises one or more n-butyl acetate, t-butyl acetate, isobutyl acetate, propyl acetate, isopropyl acetate, methyl acetate, and ethyl acetate. In other embodiments, the solvent comprises one or more amyl acetate-n, ethylene glycol ether acetate, 2-butoxyethyl acetate, and diethylene glycol monobutyl ether acetate.

Another aspect of the invention provides the preparation method of bio-based, high-solid low-viscosity acrylic resin. The preparation process consists of the following steps: (i) Setting up a clean and dry reactor, ensuring the pipeline is smooth, all instruments, valves, and motors are functioning correctly, and utilizing steam, water cooling, stirring, a vacuum pump, a nitrogen bottle, and similar equipment as needed. (ii) Adding low-toxic solvent into the reactor, heat it to a temperature of 60-160° C., introducing nitrogen to eliminate oxygen from the reactor. (iii) Combining the monomers and initiator in a separate flask, and stirring them at a temperature of 20-30° C. until the mixture becomes clear and transparent. (iv) Adding the monomers into the mixture dropwise for 6-8 hours while maintaining the reactor temperature at 60-160° C. (v) Checking the acidity, viscosity, and solid content of the resin every one hour during the reaction. (vi) Terminating the reaction once the solid content of the synthesized resin is above 70% and storing the resin in a well-sealed container.

The selection of reaction temperature is influenced by the properties of the solvent. The chosen temperature is typically set below the boiling point of the solvent to control evaporation during polymerization. The other consideration includes ensuring the solubility of monomers and initiators, maintaining a controlled viscosity, and impacting the overall reaction kinetics. For instance, the reaction temperature needs to be adjusted in the range of 120-135° C., when n-butyl acetate is used as solvent. The reaction time takes 6-8 hours depending on the monomer composition. The resin must be stored in a cool, dry place away from direct sunlight and extreme temperatures. The containers must be sealed tightly to prevent moisture and contaminants.

In the synthesis of high-solid acrylic resin, it is crucial to strictly follow the specified reaction temperature and dosing times for the monomers outlined in the procedure. Any deviation from this procedure can alter the application properties of the resulting resin. Parameters such as viscosity and color also need close attention. The developed product serves versatile purposes: it can be applied as paint in formulations, used as a topcoat varnish, or as a component in coatings. This adaptability makes it suitable for various finishing applications.

The invention is further described by the following non-limiting examples which further describe the invention clearly and comprehensively. It is important to note that these described examples are just small parts of the embodiments within the present invention, not encompassing all possible embodiments. Those skilled in the relevant field, without the need for additional creative efforts to create other embodiments, are considered within the scope of protection of the invention based on these examples.

Example 1. Reference (Without bio-Based Acrylate)

In accordance with the current procedure, the reference product is prepared according to the following formulation. 25 g of n-Butyl Acetate is weighed and placed into the reaction flask. The mixture composed of 4 grams of Methacrylic Acid (MAA), 4 grams of Cardura E10, 12 grams of 2-Hydroxyethyl Methacrylate (HEMA), 80 g of Methyl Methacrylate (MMA), and 0.5 g of Trigonox B is transferred to the dosing unit. The reaction setup is placed in a four-necked reaction flask under a backflow cooler and nitrogen flow. The apparatus is fixed onto the Magnetic Stirrer Heater. The temperature is gradually increased until n-Butyl Acetate reaches 126° C., and when reflux is observed, the dosing of monomers is adjusted to take place over 6 hours using a peristaltic pump. During the ongoing reaction, acidity, solidity, and viscosity are checked every hour. When all the monomers converted to polymers, the reaction is terminated. The resulting resin displays a solid content of 75.6, a number-average molecular weight (Mn) of 14551, a weight-average molecular weight (Mw) of 28716, and a dispersed index (PDI) of 1.98. The final acid value of the resin is 8.2 mg KOH/g and the viscosity is 9326 cP.

Example 2. The Effect of SMA

First, 25 grams of n-Butyl Acetate are carefully measured and placed into the reaction flask. Next, a mixture containing 4 grams of Methacrylic Acid (MAA), 4 grams of Cardura E10, 12 grams of 2-Hydroxyethyl Methacrylate (HEMA), 80 grams of stearyl methacrylate (SMA), and 0.5 grams of Trigonox B is transferred to the dosing unit. The reaction setup is arranged in a four-necked reaction flask, equipped with a backflow cooler and a steady nitrogen flow. This entire apparatus is secured onto the Magnetic Stirrer Heater. The temperature is gradually raised until N-Butyl Acetate reaches 126° C. Once reflux is observed, the dosing of the monomers is carefully regulated to occur for 6 hours, facilitated by a peristaltic pump. Throughout the reaction process, regular checks are made on acidity, solidity, and viscosity, with hourly assessments. When all the monomers converted to polymers, the reaction is terminated. The resulting resin displays a solid content of 75.2, a number-average molecular weight (Mn) of 10792, a weight-average molecular weight (Mw) of 20980, and a dispersed index (PDI) of 1.94. The final acid value of the resin is 7.9 mg KOH/g and the viscosity is 4231 cP. Notably, these values are lower than those observed for the reference (MMA-based) resin.

### Example 3. The Effect of LMA

First, 25 grams of n-Butyl Acetate are carefully measured and placed into the reaction flask. Next, a mixture containing 4 grams of Methacrylic Acid (MAA), 4 grams of Cardura E10, 12 grams of 2-Hydroxyethyl Methacrylate (HEMA), 80 grams of lauryl methacrylate (LMA), and 0.5 grams of Trigonox B is transferred to the dosing unit. The reaction setup is arranged in a four-necked reaction flask, equipped with a backflow cooler and a steady nitrogen flow. This entire apparatus is secured onto the Magnetic Stirrer Heater. The temperature is gradually raised until N-Butyl Acetate reaches 126° C. Once reflux is observed, the dosing of the monomers is carefully regulated to occur for 6 hours, facilitated by a peristaltic pump. Throughout the reaction process, regular checks are made on acidity, solidity, and viscosity, with hourly assessments. When all the monomers converted to polymers, the reaction is terminated. The resulting resin displays a solid content of 75.1, a number-average molecular weight (Mn) of 8364, a weight-average molecular weight (Mw) of 14728, and a dispersed index (PDI) of 1.76. The final acid value of the resin is 7.78 mg KOH/g and the viscosity is 1560 cP. This indicates a significant reduction in these values upon substituting SMA with LMA.

### Example 4. The Combination Effect of LMA and SMA

First, 25 grams of n-Butyl Acetate are carefully measured and placed into the reaction flask. Next, a mixture containing 4 grams of Methacrylic Acid (MAA), 4 grams of Cardura E10, 12 grams of 2-Hydroxyethyl Methacrylate (HEMA), 40 grams of lauryl methacrylate (LMA), 40 grams of stearyl methacrylate (SMA) and 0.5 grams of Trigonox B is transferred to the dosing unit. The reaction setup is arranged in a four-necked reaction flask, equipped with a backflow cooler and a steady nitrogen flow. This entire apparatus is secured onto the Magnetic Stirrer Heater. The temperature is gradually raised until Butyl Acetate reaches 126° C. Once reflux is observed, the dosing of the monomers is carefully regulated to occur for 6 hours, facilitated by a peristaltic pump. Throughout the reaction process, regular checks are made on acidity, solidity, and viscosity, with hourly assessments. When all the monomers converted to polymers, the reaction is terminated. The resulting resin displays a solid content of 75.4, a number-average molecular weight (Mn) of 9578, a weight-average molecular weight (Mw) of 16204, and a dispersed index (PDI) of 1.69. The final acid value of the resin is 7.67 mg KOH/g and the viscosity is 2350 cP.

In addition to the specified bio-based long-chain acrylate monomers, low-toxic solvents, and initiators outlined above, the present invention offers flexibility and versatility by accommodating a diverse array of other bio-based acrylates, solvents, and initiators. This expansive range of options enables users to tailor the formulation according to specific requirements, optimizing the benefits derived from this inventive process.

Bio-based acrylates. In some embodiments, the bio-based acrylates comprise one or more octadecyl methacrylate, octadecyl acrylate, hexadecyl acrylate, and hexadecyl methacrylate. In other embodiments, the bio-based acrylates comprise one or more bio-based alkyl acrylates/methacrylates such as decyl acrylate, decyl methacrylate, dodecyl acrylate, dodecyl methacrylate, tetradecyl acrylate, tetradecyl methacrylate, icosyl acrylate and icosyl methacrylate.

In some embodiments, the bio-based acrylates comprise one or more ligno-cellulosic-derived acrylates such as vanillin methacrylate, methacrylated vanillyl alcohol, syringaldehyde methacrylate guaiacol methacrylate, and eugenol methacrylate. In other embodiments, the bio-based acrylates comprise one or more acrylates derived from terpenes and terpenoids such as (+)-α-pinene acrylate, (−)-β-pinene acrylate, (r)-(+)-limonene acrylate, (r)-(−)-carvone acrylate, (+)-α-pinene methacrylate, (−)-β-pinene methacrylate, (r)-(+)-limonene methacrylate, (r)-(−)-carvone methacrylate, citronellyl acrylate, citronellyl methacrylate, sobrerol acrylate, and sobrerol methacrylate.

In some embodiments, the bio-based acrylates comprise one or more lactic acid-derived acrylates such as methyl lactate acrylate, ethyl lactate acrylate, n-propyl lactate acrylate, n-butyl lactate acrylate solketal acrylate, and a-pinene acrylate. In other embodiments, the bio-based acrylates comprise one or more acrylates derived from isosorbide such as acetylated methacrylic isosorbide, acetylated acrylic isosorbide, isosorbide acrylate, and isosorbide methacrylate.

In some embodiments, the bio-based acrylates comprise one or more acrylates derived from vegetable oils such as solketal acrylate, solketal methacrylate, and glycerin carbonate acrylate. In other embodiments, the bio-based acrylates comprise one or more acrylates derived from levoglucosenone such as methacrylated dihydro-5-hydroxyl furan-2-one (m-2h-HBO) and methacrylated cyrene.

In some embodiments, the bio-based acrylates comprise one or more glycerol-derived acrylates such as 2-octyl acrylate and isobornyl methacrylate (iboma). In other embodiments, the bio-based acrylates comprise one or more acrylates derived from fatty acids such as cardanol methacrylate.

Initiator. Except dialkyl peroxides, the initiator for preparing acrylic resin can be selected from hydroperoxides, peroxyketal, and peroxyesters. In some embodiments, the initiator comprises one or more hydroperoxides such as tert-butyl hydroperoxide (Trigonox A), cumene hydroperoxide (Trigonox C), and Diisopropylbenzene Hydroperoxide (Trigonox IPH). In other embodiments, the initiator comprises one or more peroxyesters such as tert-butyl peroxy-2-ethylhexanoate (Trigonox 21S), tert-amyl peroxy-2-ethylhexanoate (Trigonox 121), tert-butyl peroxy-3,5,5-trimethylhexanoate (Trigonox 42S) 1, and tert-amyl peroxy-3,5,5-trimethylhexanoate (Luperox 570).

In some embodiments, the initiator comprises one or more peroxyketals such as 1-di-(tert-butyl peroxy) cyclohexane (Trigonox 22-E50), 1,1-di-(tert-amyl peroxy) cyclohexane (Trigonox 122-C80). In other embodiments, a combination of peroxides, peroxyketal, and peroxyesters can be used as an initiator. Yet in other embodiments, 2,2′ azodi (2-methyl butyronitrile), azobisisobutyronitrile, ethyl 3,3-di (t-amylperoxy) butyrate and t-butyl peracetate can be also used as an initiator.

Solvent. In some embodiments, the solvent comprises one or more terpene-derived solvents such as turpentine, limonene and para-cymene. In other embodiments, the solvent comprises one or more soybean-derived solvents such as methyl soyate, soy methyl ester and soy fatty acid methyl ester.

In some embodiments, the solvent comprises one or more 2-methyltetrahydrofuran (2-methf), 2,2,5,5-tetramethyloxolane (tmo), 2,5-dimethyltetrahydrofuran (dmethf) and pinacolone. In other embodiments, the solvent comprises one or more butyl lactate, methyl lactate, and ethyl (−)-I-lactate. In another embodyment, the solvent comprises one or more cyclopentyl methyl ether (cpme), diethyl carbonate, propylene carbonate, and dimethyl carbonate. In another embodyment, the solvent comprises one or more cyrene, dimethyl isosorbide, y-valerolactone (gvl), 2-methyltetrahydrofuran. Yet, in another embodiment, the solvent comprises one or more methyl ethyl ketone (MEK), ethyl 3-ethoxypropionate, dimethyl adipate, and dimethyl glutarate.

1. (canceled)

2. (canceled)

3. (canceled)

4. (canceled)

5. (canceled)

6. (canceled)

7. (canceled)

8. (canceled)

9. (canceled)

10. (canceled)

11. A bio-based acrylic resin having a solids content above 70% and viscosity less than 20000 cP prepared from a composition comprising:
20 to 80 parts by weight of bio-based acrylate;
8 to 12 parts by weight of at least one of 2-hydroxyethyl methacrylate and 2-hydroxyethyl acrylate and 2-hydropropyl methacrylate;
10 to 30 parts by weight of a solvent;
3 to 5 parts by weight of at least one of methacrylic acid and acrylic acid;
3 to 5 parts by weight of a glycidyl ester of neodecanoic acid; and
0.3 to 5 parts by weight of an initiator.

12. The composition of claim 11, wherein the bio-based acrylate is a long-chain n-alkyl acrylate to methacrylate selected from the group consisting of stearyl acrylate, stearyl methacrylate, lauryl acrylate, lauryl methacrylate, behenyl acrylate, behenyl methacrylate, and mixtures thereof, wherein the long-chain n-alkyl acrylate/methacrylates is expressed as:

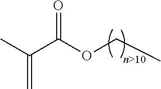

13. The composition of claim 11, wherein the bio-based acrylate is from a long-chain n-alkyl acrylate or methacrylates selected from the group consisting of octadecyl methacrylate, octadecyl acrylate, hexadecyl acrylate, hexadecyl methacrylate, and mixtures thereof.

14. The composition according to claim 11, wherein the bio-based acrylate is a bio-based long chain n-alkyl acrylates and methacrylates selected from the group consisting of decyl acrylate, decyl methacrylate, dodecyl acrylate, dodecyl methacrylate, tetradecyl acrylate, tetradecyl methacrylate, icosyl acrylate, icosyl methacrylate, and mixtures thereof.

15. The composition of claim 11, wherein the solvent is selected from the group consisting of n-butyl acetate, t-butyl acetate, isobutyl acetate, propyl acetate, isopropyl acetate, methyl acetate, ethyl acetate, and mixtures thereof.

16. The composition of claim 11, wherein the solvent is selected from the group consisting of amyl acetate-n, ethylene glycol ether acetate, 2-butoxyethyl acetate, diethylene glycol monobutyl ether acetate, and mixtures thereof.

17. the composition of claim 11, wherein the initiator is a dialkyl peroxide selected from the group consisting of d-t-butyl peroxide, d-t-amyl peroxide, diethyl peroxide, diisopropyl peroxide, diisobutyl peroxide, and mixtures thereof.

18. the composition of claim 11, wherein the initiator is a hydroperoxide selected from the group consisting of tert-butyl hydroperoxide, cumene hydroperoxide, diisopropylbenzene hydroperoxide, tert-butyl peroxy-2-ethylhexanoate, tert-amyl peroxy-2-ethylhexanoate, tert-butyl peroxy-3,5,5-trimethylhexanoate, tert-amyl peroxy-3,5,5-trimethylhexanoate; 1-di-(tert-butyl peroxy) cyclohexane, 1,1-di-(tert-amyl peroxy) cyclohexane, and mixtures thereof.

19. The composition of claim 11, wherein the initiator is selected from the group consisting of 2,2′ azodi (2-methyl butyronitrile), azobisisobutyronitrile, ethyl 3,3 di (t amylperoxy) butyrate, t butyl peracetate, and mixtures thereof.

20. A method of preparing the bio-based high-solid acrylic resin with solid content above 70% and viscosity lower than 20000 cP of claim 11, the method comprising:
a) heating 10-30 parts by weight of the solvent to a temperature of 60-160 under an inert atmosphere;
b) preparing a mixture of 20-80 parts by weight of the bio-based acrylates, 8-12 parts by weight of the 2-hydroxyethyl methacrylate or the 2-hydroxyethyl acrylate or the 2-hydropropyl methacrylate, 3-5 parts by weight of the methacrylic acid or the acrylic acid, 3-5 parts by weight of the glycidyl ester of neodecanoic acid, 0.3-5 parts by weight of the initiator, at a temperature of 20-30° C. and stirring until the mixture becomes clear and transparent;
c) adding the prepared mixture to the solvent dropwise while maintaining the temperature at 60-160° C.;
d) checking the viscosity and solids content every one hour of a reaction following the step of adding;
e) terminating the reaction once the solids content is above 70%; and
f) storing the resin.

21. The composition of claim 11, wherein the bio-based acrylate is at least one of lauryl methacrylate and stearyl methacrylate.
